(19) United States
(12) Patent Application Publication
(10) Pub. No.: US 2008/0097731 A1
(43) Pub. Date: Apr. 24, 2008

(54) System and method for graphically displaying information concerning geographically dispersed assets

(75) Inventors: Troy E. Lanes, Belgrade, MT (US); Jonathan P. Moberley, Bozeman, MT (US); David A. Ronsen, Bozeman, MT (US); Gary A. Naden, Bozeman, MT (US)

Correspondence Address: ANTOINETTE M. TEASE, P. O. BOX 51016, BILLINGS, MT, 59105, US

(73) Assignee: Orbit One Communication Inc., Bozeman, MT (US)

(21) Appl. No.: 11/583,417

(22) Filed: Oct. 18, 2006

(51) Int. Cl. G06F 17/10

(52) U.S. Cl. 703/2

(57) ABSTRACT

A system and method for graphically displaying information concerning geographically dispersed assets. The system comprises a computer program that associates map and/or geographical data with a physical asset; an icon or other graphical representation of each dispersed asset; and an automatic grouping function that combines at least two of the assets into a single icon or other graphical representation of the multiplicity of assets and generates a shape that represents the grouped assets. The method comprises the steps of using a computer program to associate map and/or geographical data with a physical asset; representing each dispersed asset with an icon or other graphical representation on a display; and using an automatic grouping function to combine at least two of the assets into a single icon or other graphical representation of the multiplicity of assets and generate a shape that represents the grouped assets.

### BACKGROUND OF THE INVENTION

1. Field of the Invention

The present invention relates generally to the field of computer-implemented inventions, and more generally, to a system and method for graphically displaying information concerning geographically dispersed assets.

2. Description of the Related Art

Logistics management of large numbers of items is always difficult and often defines the competitive landscape of business. The need to organize, locate and retrieve thousands of assets in one facility or site has lead to a variety of systems, such as bar coding or RFID (radio frequency identification) tagging. These systems, however, become ineffective when the assets to manage are widely—or even globally—dispersed. Recent communications technology has led to asset tags, which are capable of being affixed to mobile and widely dispersed items. These tags have the ability to report critical information over long-distance communications links that aid the asset manager in the task of routing, servicing or retrieving the items.

Technology continues to improve both the quality and quantity of data collected. As more and more assets become tagged, creating an increase in raw data, it becomes increasingly difficult for the asset manager to ascertain value from the overload of data inputs. This is especially true for graphic representation of assets, such as mapping. While prior art contains many examples of mapping tools, these tools are simply overloaded when presented with thousands or tens of thousands of concurrent assets or data points. Additionally, the usage shift by asset managers from fixed facilities to field operation further stresses prior art because the data is optimally transmitted wirelessly for these large sets of remote assets, which in turn creates very long delays in download with high costs. This renders standard mapping and display technology unsuitable for field use with large numbers of monitored assets.

Only recently has technology advanced to enable tracking and monitoring devices that are regionally or globally dispersed in location. The proliferation of low-cost satellite communications and wide-area cellular data service has enabled a new set of devices capable of monitoring movement, alarm or security status, or collections of industrial data. These devices often relay data to other machines, which in turn control processes that make true machine-to-machine, long-distance functionality a present day reality.

The availability of these low-cost, widely-dispersed devices creates real problems for asset managers charged with monitoring or controlling these processes. In the past, most asset monitoring functions were constrained to local geographies, using bar coding or RFID technology, and often only able to relay where and when a specific item or palette of items arrived, was moved or left a facility. To monitor assets en route with this technology requires coordinated logistics functions at important way-stations, field transfer points, and destination facilities. Examples of the present methods include the U.S. Postal Service, commercial shipping and consumer goods inventory control. The complexity of these systems is often limited by cost in that the information, while valuable, must be delivered in a cost-effective manner. To manage assets over wide areas of dispersion, such as nationally or globally, greatly increases these costs. As such, these systems are generally used in connection with business opportunities that can sustain the value-to-cost analysis. Moreover, because of the limitations of existing technology (such as bar code scanners or RFID tags that have short-range operation), it is seldom useful to display location information graphically, as in mapping, because the devices are typically detected at known locations. Mapping only becomes useful when the device has long-range communications capability.

The recent deployment of data service satellite and telephony products have ushered in new products and capabilities that are forcing logistics managers to rethink the problems of the past. Managers wishing to monitor movement of assets abroad may now receive in real-time, or near real-time, information as to the whereabouts and/or input status of mobile assets. Additionally, these assets may relay information orders of magnitudes more often than that of prior art tracking technology. For example, a crate of goods moved from one warehouse in California to another in New York may be scanned only a few times as the crate transitions from carrier to carrier and is finally received at the destination. Modern day asset tags, on the other hand, have the capability of reporting location or data every hour, or every few minutes, or in some cases every second. This creates huge amounts of data that overload and obscure meaningful information—the data is often more than desired or truly needed by the logistics manager. Additionally, since the manager typically monitors many devices, the problem is multiplied, creating an impossible job for realistically monitoring and controlling assets.

This problem is further compounded by the lowering costs associated with these types of systems. In the recent past, it would have cost thousands of dollars monthly to monitor a single truck or ship. The cost associated with achieving mobile monitoring was often borne only by most critical needs, such as government or military operations. Now, these technologies are being offered for tens of dollars per month, and in some cases with free hardware and no limitations for data use, which essentially encourages users to maximize the report rate. The result is that low-cost devices, plus low-cost messaging that operates over widely dispersed areas using wireless technology, create astronomical data management problems for logistics managers, who must sift through millions of pieces of data every day. This has become the modem-day equivalent of finding a specific needle in a needle stack.

With so much data to sift, it becomes critical to somehow relay the important information to logistics managers. Often the most critical information to be relayed is location, time and status. Operators typically care most about where a device is located or where it last reported. Data prior to the recent report is often not valuable in and of itself, but it can extremely valuable to investigate the location history of a single asset or small groups of assets. Most present day graphic representations report only current location of assets. Many companies provide these types of graphic services for monitoring the location of remote assets, but only recently the cost for asset tags has dropped, and the industry is seeing exponential increase in the number of tags being displayed. Even if current monitoring devices show only the last location of an asset, they are overwhelmed in terms of capability to depict the device locations due to the number of elements to be displayed at one time, as well as the ability to transmit that much data over wireless or low data rate links. Because the cost of assets tags has come down, the number of uses has increased, which in turn leads to the root cause of the deficiency of current tools.

In 2000, the number of commercial trailers being monitored in the United States by any single company was roughly a mere 70K, with the majority of these assets at trailer storage yards, unpowered and non-operative. At any one time, only 20K to 30K of these devices were reporting and monitored, with the devices spread over at least three companies employing dozens of managers. These devices were based on cellular telemetry technology, utilizing existing analog cellular service and providing utility to about forty percent (40%) of the geographic region of the United States.

In 2005 and 2006, with the introduction of global satellite packet telemetry service from Globalstar of Milpitas, Calif., and Iridium of Bethesda, Md., over 35K devices were deployed globally by Orbit One Communication Inc. of Bozeman, Mont., to a single customer, and all were fully operational non-stop, day and night. The assets tagged were used in the Gulf State regions in support of Hurricane Katrina aid and recovery and represent less than ten percent (10%) of the total assets planned to be tagged in the next twenty-four (24) months. Additionally, cellular 911 service that enables wireless telephones with GPS has created a new class of tracking devices now launched by nearly every cellular service provider. These devices can be configured to transmit location every second and are often sold on “all-you-can-eat” plans that offer a fixed cost per month for unlimited messaging. This technology, now field proven to be cost-effective and a fraction of the cost of prior technology, has gained the attention of very large opportunities with volumes projected in the millions of devices by end of the decade. This spike in communications products and technology creates immediate problems for processing the data, especially graphically.

Two problems exist for asset managers, both dealing with effective use of time and data. First, the manager trying to monitor 100K devices alone cannot effectively differentiate that many items on one computer display. All map information is obscured by the symbol used to represent the asset, and all asset information is obscured by additional asset information adjacent to the desired item. The display becomes unusable as asset textual or graphical tags overlap important map features or other asset data. While this problem is not new, the scope of the problem is new. In the past, logistic managers would decrease the map scale, zooming into the asset until it could be differentiated sufficiently. In very dense conditions, the manager could manually group the items and create reports to extract the data from the few or one desired. This approach becomes untenable for an operator charged with monitoring tens or hundreds of thousands of assets graphically.

With the logistics task shifting from local to widely dispersed assets, it also becomes necessary for many managers to gain access to the same data, while operating in the field, mobile and remote. This creates several problems for the tools used to retrieve and display the large amounts of data provided by these low-cost asset tags.

In order for multiple people to gain simultaneous access to the data, the data needs to be collected and managed in a database for access. This data collection typically merges data from a multiplicity of systems and endpoint device types. For example, a total asset visibility system may merge RFID, barcode scanned entries and mobile satellite-based asset tag data to create a total supply chain visibility report. Getting the data into one central or distributed database is no small task, but there exist today several systems that approach or accomplish the task to varying degrees of utility. Next comes the task of simultaneously retrieving the data by many users. Use of the internet has resolved some of the problem, as long as the user has hard-wired access. A problem exists when field mobile managers must access the data using wireless communications. The state of the art today includes wireless internet connections with speeds up to hundreds of kilobytes per second, but even these interfaces have difficulty transferring millions or billions of bytes of information. The data issue is further compounded if map information must also be relayed. Costs for transmitting millions or billions of bytes also presents a real negative to the manager.

Typically, a partial solution to the data problem for mobile applications is referred to as thick client, which means that the user installs a program or programs on the mobile computer that contains as much of the required information as possible, for example, a map database. This requires that any mobile user must have previously installed the thick client software application prior to use in the field, often at significant expense per installation. Even with thick client application, display of thousands or hundreds of thousands of assets to the user requires large data downloads that take many minutes over today's wireless cellular systems.

Accordingly, it is an object of the present invention to provide a method for graphically displaying complete and useful information for large volumes of remotely dispersed individually tagged assets.

It is a further object of the present invention to provide a method for automatically grouping assets and displaying these grouped assets in graphical representations that intuitively communicate the content and dispersion of the obscured, grouped assets.

Yet another object of the present invention is to provide a method for deriving a shape for the auto-grouped assets into an icon used to represent the assets for presentation. The shape and location of the icon is representative of the asset represented.

It is a further object of the present invention to provide a method for using thin-client mapping software applications suitable for use in remote locations but capable of displaying very large sets of mapping information. This enables many users to access large data sets without the need to install software on the user's computer or download large amounts of asset or mapping data.

Yet another object of the present invention is to provide a method for decimating a number of points from a specific asset with an automatically determined decimation ratio so as to provide an auto-scaled breadcrumb trail for a high transmit rate asset tracking device.

### BRIEF SUMMARY OF THE INVENTION

The present invention is a system and method for graphically displaying information concerning geographically dispersed assets. The system comprises a computer program that associates map and/or geographical data with a physical asset; an icon or other graphical representation of each dispersed asset; and an automatic grouping function, wherein the automatic grouping function combines at least two of the assets into a single icon or other graphical representation of the multiplicity of assets, and wherein the automatic grouping function generates a shape that represents the grouped assets. Preferably, the automatic grouping of dispersed assets proportionally reduces data transmitted to a remote display terminal.

In a preferred embodiment, the automatic grouping function partitions the display into regions, sums the number of assets in each region, compares each sum of assets to a threshold, and groups assets in a region that exceeds a given threshold. Optionally, each display region comprises one or more boundaries, and the automatic grouping function determines whether any of the asset groups share a point or points on a region boundary, and if so, whether any adjacent groups share the same point or point on the same region boundary, and if so, combines the groups into a single group.

In one embodiment, the automatic grouping function calculates candidate nearest neighbor assets within a limit distance for each asset, calculates a center of mass for the candidate nearest neighbor assets, calculates a radial shape range using the calculated center of mass as origin, and concatenates radial shape ranges that overlap to create groups of assets inside the limit distance that was used to perform the nearest neighbor calculation. In another embodiment, the automatic grouping function calculates a radial region around each asset and concatenates overlapping radial regions to define assets to be grouped.

In yet another embodiment, the shape representing the grouped assets is generated using concatenated areas of calculated Voronoi regions. Preferably, the automatic grouping function calculates a Voronoi region set for each asset, calculates the area of each Voronoi region, compares each region to a threshold, and concatenates adjacent regions that are below the threshold to define the assets to be grouped.

In a preferred embodiment, the automatic grouping function calculates a data region for each asset, determines whether any of the data regions overlap, and groups assets that have overlapping data regions, and the data region comprises data to be displayed adjacent to the icon or other graphical representation of the asset.

In one embodiment, the shape representing the grouped assets is generated using a convex hull algorithm. In an alternate embodiment, the shape representing the grouped assets is generated using an arithmetic weighted center of mass algorithm. In another alternate embodiment, the shape representing the grouped assets is generated using concatenated radial circle areas around nominated assets.

In a preferred embodiment, the map and/or geographical data associated with an asset is displayed on a remote display terminal, the data for any given asset is associated with a number of data points, a first data point for a given asset is plotted, and successive data points for the same asset are skipped using a decimation algorithm until all of the data points for a given asset have been exhausted. In a first embodiment, the decimation algorithm comprises skipping plotting successive data points of the same asset until a successive data point is at least a minimum distance from the previous data point. In a second embodiment, the decimation algorithm comprises skipping plotting successive data points of the same asset using a set decimation ratio. In a third embodiment, the decimation algorithm comprises skipping plotting successive data points of the same asset according to a minimum time difference using time data associated with each data point. In a fourth embodiment, the decimation algorithm comprises skipping plotting successive data points of the same asset until a data component associated with each data point is in the range of a prescribed threshold.

In a preferred embodiment, the computer program operates as a thin client application, the computer program receives the map and/or geographic data wirelessly, and the data is automatically grouped proportionally to the display resolution prior to wireless communication.

The method of the present invention comprises the steps of using a computer program to associate map and/or geographical data with a physical asset; representing each dispersed asset with an icon or other graphical representation on a display; and using an automatic grouping function to combine at least two of the assets into a single icon or other graphical representation of the multiplicity of assets and generate a shape that represents the grouped assets. Preferably, the automatic grouping of dispersed assets proportionally reduces data transmitted to a remote display terminal.

In a preferred embodiment, the method further comprises using the automatic grouping function to partition the display into regions, sum the number of assets in each region, compare each sum of assets to a threshold, and group assets in a region that exceeds a given threshold. Optionally, each display region comprises one or more boundaries, and the method further comprises using the automatic grouping function to determine whether any of the asset groups share a point or points on a region boundary, and if so, whether any adjacent groups share the same point or points on the same region boundary, and if so, combine the groups into a single group.

In one embodiment, the method further comprises using the automatic grouping function to calculate candidate nearest neighbor assets within a limit distance for each asset, calculate a center of mass for the candidate nearest neighbor assets, calculate a radial shape range using the calculated center of mass as origin, and concatenate radial shape ranges that overlap to create groups of assets inside the limit distance that was used to perform the nearest neighbor calculation. In another embodiment, the method further comprises using the automatic grouping function to calculate a radial region around each asset and concatenate overlapping radial regions to define assets to be grouped.

In yet another embodiment, the method further comprises using concatenated areas of calculated Voronoi regions to generate the shape representing the grouped assets. Preferably, the method further comprises using the automatic grouping function to calculate a Voronoi region set for each asset, calculate the area of each Voronoi region, compare each region to a threshold, and concatenate adjacent regions that are below the threshold to define the assets to be grouped.

In a preferred embodiment, the method further comprises using the automatic grouping function to calculate a data region for each asset, determine whether any of the data regions overlap, and group asset that have overlapping data regions, and the data region comprises data to be displayed adjacent to the icon or other graphical representation of the asset.

In one embodiment, the method further comprises using a convex hull algorithm to generate the shape representing the grouped assets. In an alternate embodiment, the method further comprises using an arithmetic weighted center of mass algorithm to generate the shape representing the grouped assets. In another alternate embodiment, the method further comprises using concatenated radial circle areas around nominated assets to generate the shape representing the grouped assets.

In a preferred embodiment, the method further comprises displaying the map and/or geographical data associated with an asset on a remote display terminal, and, wherein the data for any given asset is associated with a number of data points, plotting a first data point for a given asset and skipping successive data points for the same asset using a decimation algorithm until all of the data points for a given asset have been exhausted. In a first embodiment, the decimation algorithm comprises skipping plotting successive data points of the same asset until a successive data point is at least a minimum distance from the previous data point. In a second embodiment, the decimation algorithm comprises skipping plotting successive data points of the same asset using a set decimation ratio. In a third embodiment, the decimation algorithm comprises skipping plotting successive data points of the same asset according to a minimum time difference using time data associated with each data point. In a fourth embodiment, the decimation algorithm comprises skipping plotting successive data points of the same asset until a data component associated with each data point is in the range of a prescribed threshold.

In a preferred embodiment, the computer program operates as a thin client application, the computer program receives the map and/or geographic data wirelessly, and the method further comprises automatically grouping the data proportionally to the display resolution prior to wireless communication.

### BRIEF DESCRIPTION OF THE DRAWINGS

FIG. 1 is an illustration of the high-density tracking display prevalent in the prior art.

FIG. 2 is an illustration of increasing the zoom level of FIG. 1 until the assets can be delineated.

FIG. 3 is an illustration of the increased clarity of information offered by the present invention through selectively grouping assets to be displayed.

FIG. 4 is a graphical depiction of the convex hull algorithm of prior art.

FIG. 5 shows the grid method used in the present invention for selecting individual assets to be automatically grouped.

FIG. 6 shows the result of auto-grouping the assets that were shown in FIG. 5.

FIG. 7 depicts a group of assets along a river bank.

FIG. 8 shows how the shape of a group can communicate information about the distribution of assets contained in the group.

FIG. 9 depicts an alternate algorithm for selecting assets to be grouped.

FIG. 10 depicts yet another algorithm for selecting assets to be grouped.

FIG. 11 depicts yet another algorithm for selecting assets to be grouped.

FIG. 12 depicts yet another algorithm for selecting assets to be grouped.

FIG. 13 is a graphical depiction of a single asset reporting frequently.

FIG. 14 depicts decimation of the asset shown in FIG. 13.

### DETAILED DESCRIPTION OF INVENTION

The present invention is a computer-implemented method that reduces the amount of data transferred to remote display devices while still relaying the critical information of the total assets under management. The advent of asset tracking devices employing modern wireless communication creates a significant problem when the number of assets to be displayed is large. A user trying to monitor a few assets has no difficulty monitoring and delineating them on a display terminal. When the number of assets is moderate or large, however, the display terminal becomes cluttered with information and overlapping icons.

For purposes of clarity, the following terms have the following meanings as used herein: An asset is the physical thing being monitored or tracked. The “tag” or “device” is the communications box attached to the asset and used to relay the location or status of the asset to the remote asset manager. Tags can be short-range (as in RFID, which operates over inches or feet) or long-range. Long-range communications typically operate over miles or on a global basis and may be satellite-based. The long-range devices generally have GPS (global positioning system) capability.

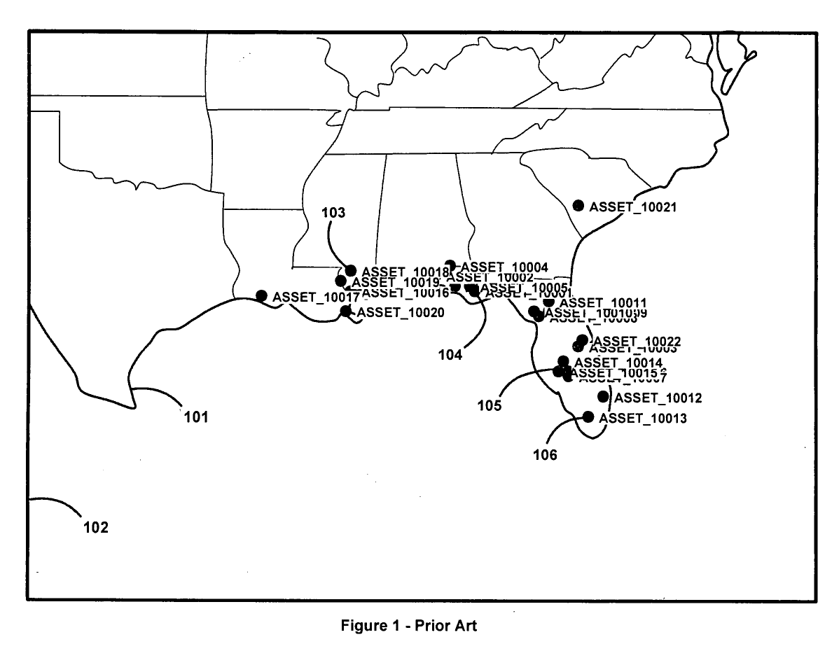

The present invention discloses a method for automatically mitigating the cluttering problem associated with displaying a large number of asset information. FIG. 1 shows the problem of displaying even a small number of 21 assets distributed in the southeast map region of the United States. The figure depicts what a user trying to view these assets on current state of the art display technology would observe.

FIG. 1 element 101 depicts the southeast region of the United States as shown on a user terminal display 102. Even with a moderately small set of 21 assets, it is difficult to clearly determine where the specific asset is located or to clearly read any data that may be displayed adjacent to the asset icon. This is shown in icons 103, 104 and 105 where individual assets are depicted with their asset identification displayed. Each of these icons as shown is accompanied by either the location or identification data obscured by other nearby assets. Assets that are geographically isolated such as 106 present no problem for relaying the information intended. The problem is to relay to the operator the information from all the assets under management in a concise and clear manner.

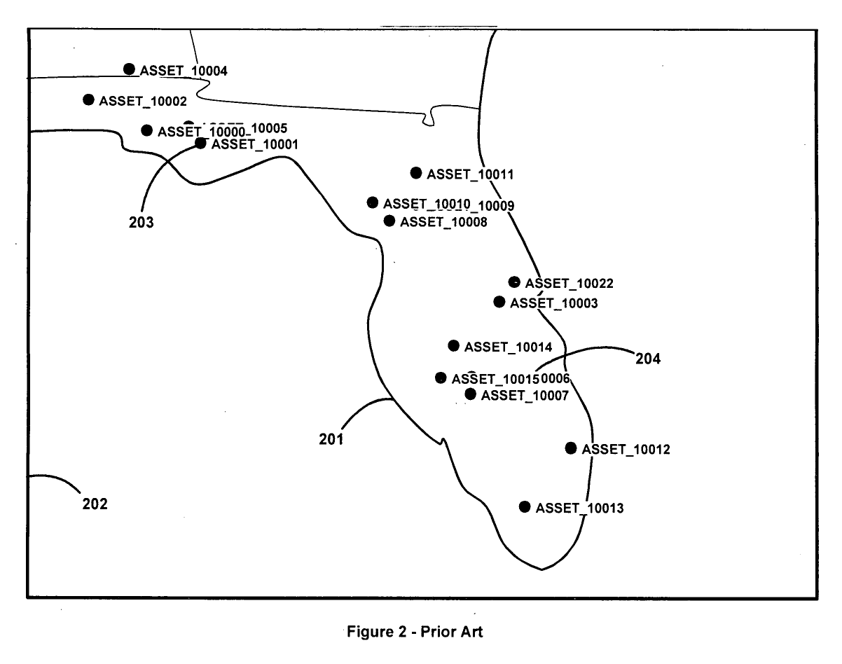

The prior art and prevalent method for resolving this issue is to “zoom and view.” The operator would select a smaller section of the display to zoom or scale the map in order to create more physical display distance for the assets to be shown. FIG. 2 depicts this “zoom and view” approach to select only those assets in Florida 201 with the intention of delineating the information shown in the display 202. This method clearly helps greatly in that the user can now largely differentiate the assets in Florida, though some limited overlap at the shown scale still occurs 203, 204. Repeating the “zoom and view” for these remaining trouble regions eventually will reveal the assets and their information for use; however, the operator has lost the ability to simultaneously monitor those assets that are no longer in the field of view. In addition, the recursive zooming is time-consuming, both from a user standpoint and due to the inherent constraints of wireless transmission. On each zoomed view, the picture is refreshed and the associated data retransmitted. This adds more time and expense to the operation.

FIGS. 1 and 2 exemplify the problem using even a small set of 21 assets. Present day managers, however, are forced to monitor tens of thousands of assets in the same region as depicted in FIGS. 1 and 2. Through the use of the present invention, the inventors solved this problem for the more than 25,000 tagged assets deployed into hurricane response regions of the southeast. It becomes untenable to use the “zoom and view” method when there are literally hundreds of assets in the same physical location. Also, most of the asset managers operated field deployed using the limited wireless connectivity that remained following the storms. These wireless connections were typically limited in data rate if available at all, so it became impossible to relay all the data from all the devices for every view the field manager selected. The inventors solved the display and communication problems using a method for automatically grouping assets for display, which also limited the amount of data relayed for any selected view.

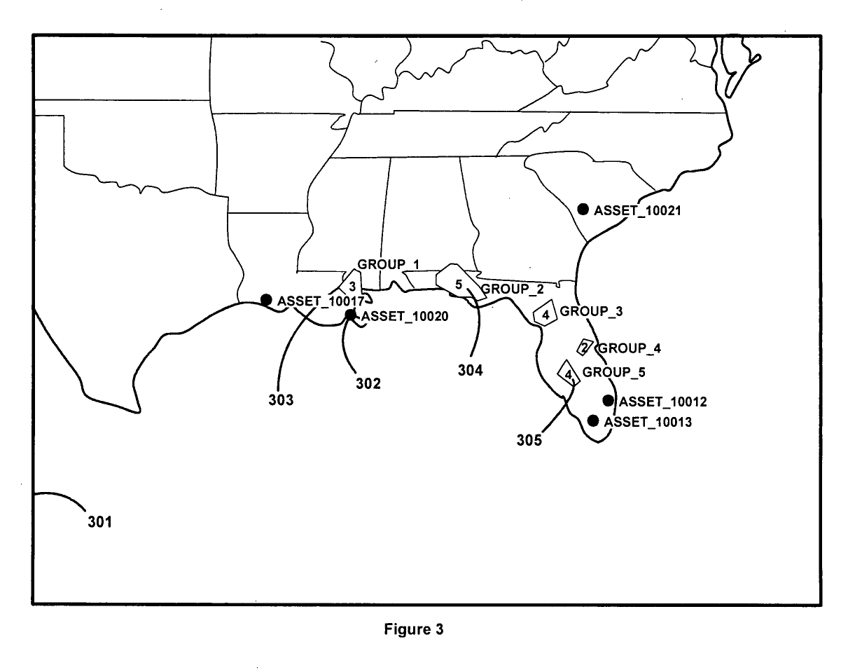

This automatic grouping function may also be performed proportional to display resolution to enable an optimal level of detail to maximize clarity of relay of information. FIG. 3 depicts the same information as shown in FIG. 1, but shows how the present invention utilizes the automatic grouping function to communicate the total asset visibility for the selected display resolution. As in FIG. 1, the same display resolution 301 is selected by the user. But unlike FIG. 1, the location and data information is clearly communicated without overlap of text or icons. Individual assets such as element 302 that are sufficiently isolated to communicate the necessary information remain unchanged. Assets that are too closely located to reliably communicate the data without overlap are automatically grouped 303, with a new reference designator applied. The shape and location of the groups 303, 304, 305 are indicative of the assets contained in the group. The present invention discloses several methods for determining which assets are to be grouped and creating the group shape with attention to computational efficiency for the endpoint display terminal.

The group shape may contain a numeric value 305 that communicates the number of devices that are contained in that group. Alternatively, the shape may include any inherent data component that relays the desired information from assets contained in the group to the user. FIG. 3, therefore, communicates clearly the situational data that is unclearly displayed in FIG. 1.

The present invention also employs context-sensitive additional data. Specifically, if a user wishes to know the detailed content or status of devices that are grouped, the user would select the group with pointer, mouse, keyboard, stylus or any other typical selection means. The detailed status for that group is displayed in a popup or status pane. In this manner, the user may monitor each group or sets of groups with simple selection means and without the need to alter zoom scale.

In addition, the present invention enables wireless operation through data reduction. Grouping assets for display minimizes the amount of data required to generate or refresh the display. When the user selects a group for more detail, only the selected information may be relayed at that time, thus removing the need to always communicate every piece of information whether the user cares about it or not.

As in FIG. 1, it is clear that the more assets to be displayed, the more difficult it is to relay accurate and clear data. By contrast, the grouping approach serves well even for applications where tens of thousands of assets are deployed. The group count can easily indicate 2 or 1000 contained devices without adding significantly to the displayed data. Typical asset field deployments split devices largely into three classes: depot storage, in transit and field deployed. Depot storage is the largest concentration of units, with thousands of devices very closely collected. Grouping works well for this class, and it becomes intuitively obvious for the user to understand how many assets are in storage.

In transit assets are often singles or small groups, so these often break out of the auto-grouping and appear as a single element 302. The same holds true for field deployed assets, which typically are scattered as individuals or in small clusters of groups.

Because the grouping is performed automatically proportional to scale of display, the user can quickly, in fewer steps, use a “zoom and view” method to evaluate a distribution of assets in local regions such as city blocks, transfer points and temporary storage locations. Users can also zoom out, to a state, national or global scale that quickly shows the distribution of assets regionally or nationally. The present invention, therefore, applies to large distributions of assets not only locally but on a global scale, providing intuitive information using simple computational means at the endpoint display terminal while minimizing on-air data communication.

One important innovation associated with the automatic grouping function is one of group shape. The group shape ideally relays information, and minimally obscures other information. For example, it is undesirable for a group to obscure the map features. One approach beyond shape is to use translucent group shapes to only partially obscure underlying map detail. Users may set as a personal preference the translucent or opaque attribute as a user preference.

Furthermore, the perimeter shape of the group should relay something about the internal distribution of assets contained in the group. Creating a group as just a large dot is helpful but not optimal as the shape communicates little about the distribution of units therein.

In a preferred embodiment, the present invention uses convex hull algorithms for creating group shapes. Although convex hull algorithms are used in one embodiment of the present invention, as explained more fully below, the present invention is not limited to any particular group shape (convex, concave, or otherwise). Convex hull algorithms are utilized in prior art for defining perimeter polygons to completely contain a given set of points in 2D or multi-dimensional space. Provided a set of points is selected for grouping, any number of convex hull algorithms would suffice. Popular algorithms such as “Grahams' Scan” [see reference 1] or “divide and conquer” [see reference 2] or “gift wrapping algorithm” [see reference 3] or any similar algorithm would suffice. These algorithms are designed to operate in multidimensional space, some up to eight dimensions of geometry. The present invention targets displaying mapping and data information to a flat panel screen; thus, in a preferred embodiment, the algorithm is optimized for 2D elements. For this purpose, the O'Rourke algorithm [see reference 4] is sufficient and computationally simple.

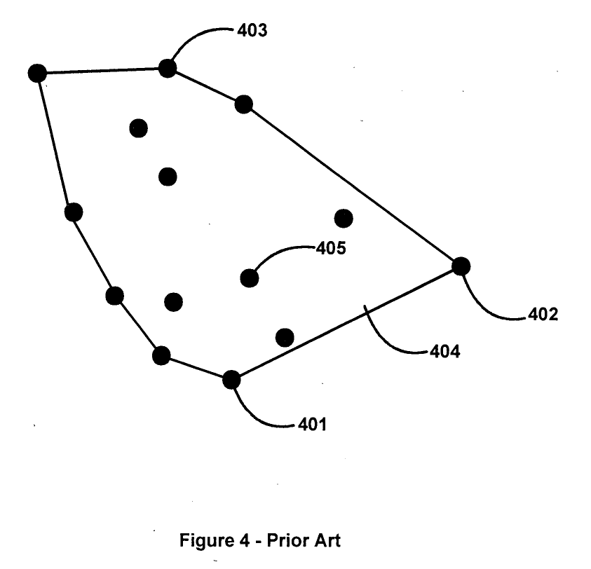

FIG. 4 depicts this convex hull process as used in prior art. The elements to be grouped are evaluated, finding the external points as exemplified by elements 401, 402 and 403. Interior points 405 that are fully contained inside perimeter polygon 404 are also contained in the group.

The problem of selecting which points in space to be group must next be solved. The present invention utilizes an automatic scaled grouping algorithm to determine which elements are to be combined into a group for display. As the display resolution is changed, the grouping function is repeated to combine and separate groups as needed to provide optimal clarity of information.

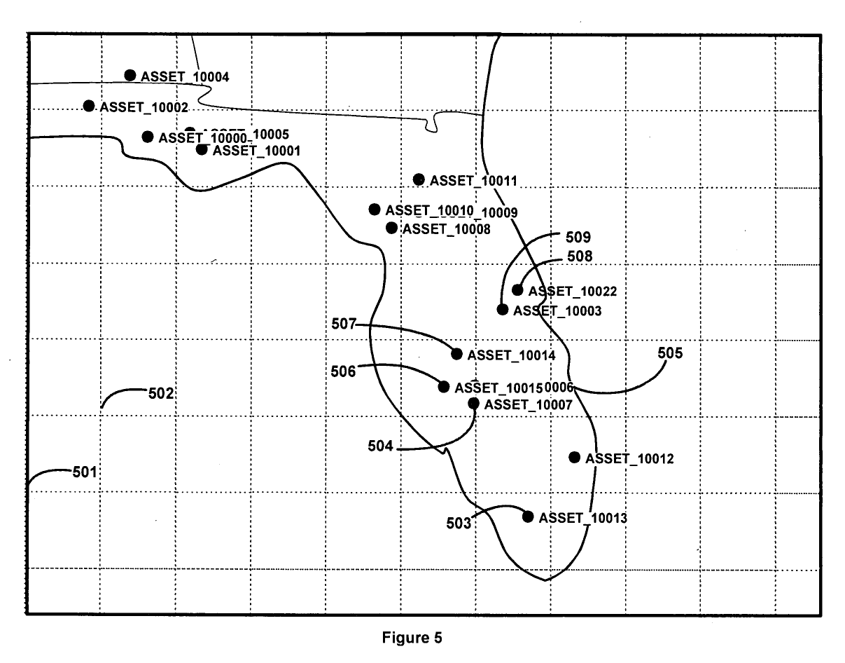

One method as used in the present invention employs the use of a coordinate grid subdividing the display data. FIG. 5 depicts the display of individual assets in Florida to be considered for grouping. The display area 501 is subdivided into coordinate grids 502. The scale of the grid may be fixed or flexible to configure the sensitivity of the operation for grouping. In one embodiment of the present invention utilizing a fixed grid, the user can change scale on the mapping data, which accomplishes the same effect as a flexible grid.

A count of assets in each grid results in a sum, which is compared to a threshold for grouping. The threshold may be fixed or variable depending on the application. For purposes of this disclosure, we shall assume the threshold to be a fixed value of 3. Grid regions that have 3 or more assets are candidates for grouping. As shown, asset 503 is a sole asset in the grid is therefore not eligible for grouping. Conversely, assets 504, 505, 506 and 507 will be grouped into one shape for representation. Assets 508 and 509, however, do not sum to the threshold, and as such are not grouped.

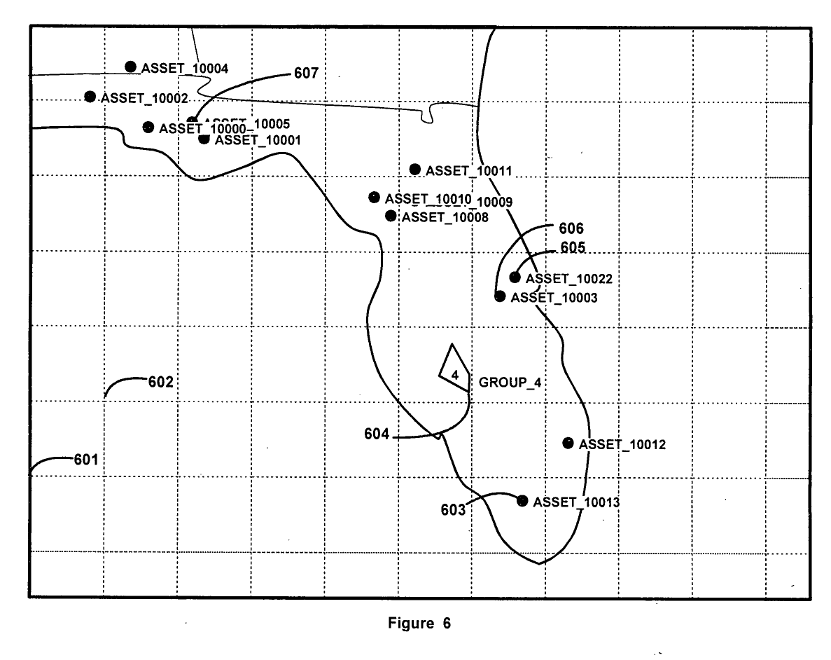

FIG. 6 depicts the result of the example discussed above. The same display resolution 601 with the same grid scale 602 results in the creation of group 604 from the elements 504, 505, 506 and 507. Assets 605 and 606 remain ungrouped as they sum less than the threshold of 3.

It is easy to see that the scale of grid and threshold provide a degree of grouping flexibility that dictate the grouping function. The grid as shown, and the threshold as stated, result in some assets remaining somewhat obscured (see, for example, asset 607). Nevertheless, the resulting displayed data is clearer and more concise than would be displayed without grouping. Also, it is clear that changing the threshold from 3 to 2 would create three additional groups that further clarify the map. It is necessary, therefore, for the user to experiment with icon size, text size, etc. in order to set the appropriate grid scale and threshold. Alternately, both the grid scale and/or threshold could be dynamically configured by the software to maintain a desired compression ratio. For example, the software could be programmed to set the grid scale based on a certain percentage of text overlap. This is but one of numerous ways in which the grid size and/or threshold could be dynamically configured by the software.

One artifact of the grid approach is that it is possible to artificially divide a set of assets that should logically be grouped because of a grid line bisecting the larger group. The grid approach (as discussed above) would produce two groups, one in each grid, but in some cases, it may be preferable for those groups to be combined. A solution to this problem is to post process the groups to determine if nearest-neighbor combining could be performed. If specific assets in two separate groups are within a threshold distance of each other, it may be used as a trigger to combine the groups into one group. This is an indication that the real physical group was arbitrarily bisected due to a grid line and not for any logical or meaningful group separation reason. This recombination, however, may or may not be necessary or even desirable as it could produce a super-group for very high density regions.

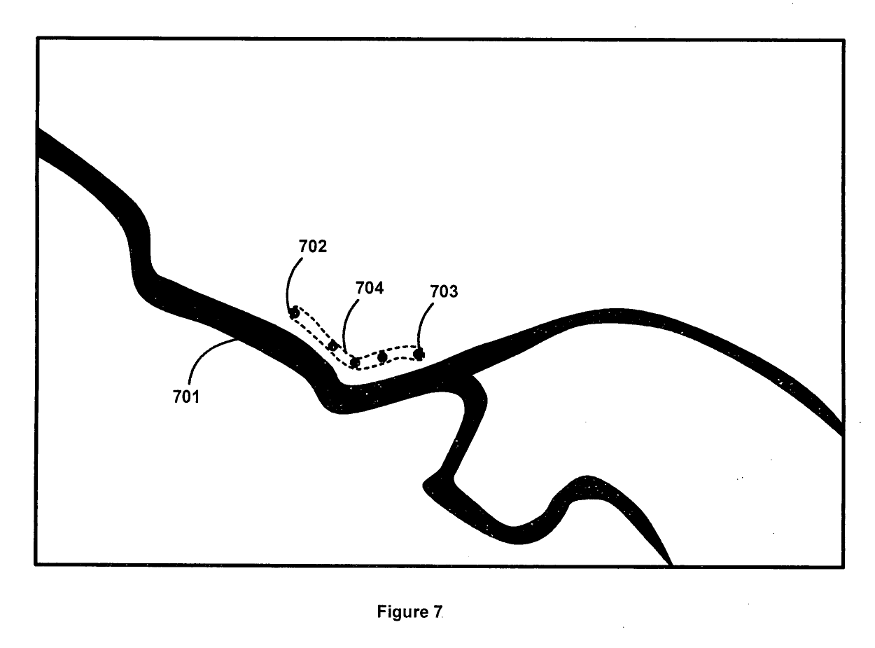

As discussed before, the shape of the group can also provide insight as to the distribution of assets contained. As shown, the shape of group 604 is rather ambiguous, largely due to the distribution of assets as found in the grid. In some cases, the shape can relay important information about the distribution, for example, if assets are distributed along a fault line or natural feature such as a river or ocean bay. FIG. 7 depicts an example distribution of assets with endpoint assets numbered 702 and 703. These assets are deployed along the bank of a river 701 with an automatic grouping that would appear as 704. The shape of group 704 intuitively communicates that the multiplicity of assets are positioned along the bank of the river. Note that the group shape need not necessarily be a convex hull. In this example, the group shape is essentially a concave hull.

Besides convex hull, there exist many other algorithms for creating shaped polygons to represent the assets grouped. Depending on the application and computational capacity, it may be desirable to incorporate alternative grouping algorithms to depict the assets contained. The end goal is to present a group shape that intuitively communicates something about the object distribution contained.

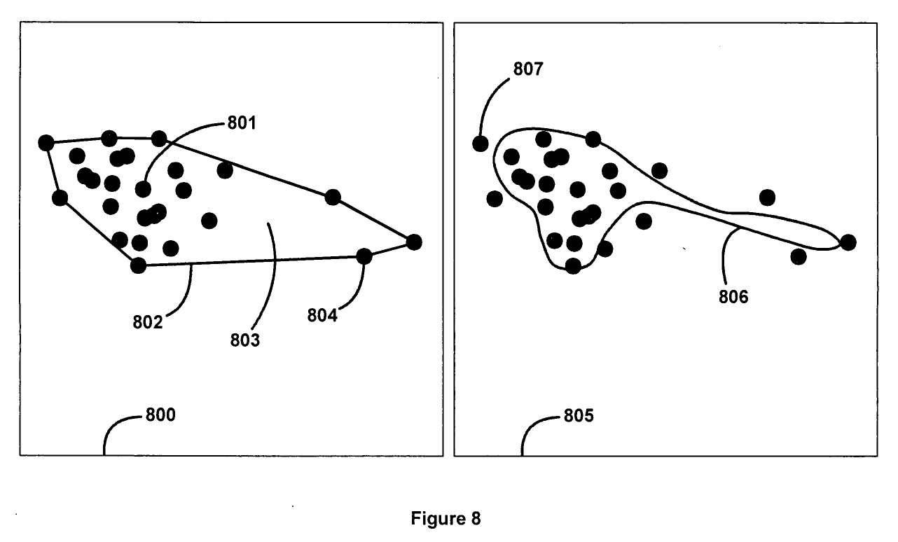

A convex hull merely draws line segments around the perimeter of points that create a polygon that completely encloses the points inside. FIG. 8 depicts how the distribution of a group may be more intuitively communicated through other shape algorithms given the computational capacity that exists in the computer performing the shape creation. Two grids are represented 800, 805 that both contain the same elements to be grouped. Grid 800 shows use of the convex hull algorithm that outlines the perimeter elements 802. The convex hull operation results in a shape that does not necessarily convey the distribution of elements contained inside. The figure shows a high density of assets near asset 801 with no elements in the middle 803 and only a few elements on the rightmost end near 804. If only the shaped group is displayed, it could be assumed that a uniform distribution of assets is contained. While this example is somewhat extreme, it does demonstrate an area for improvement over the convex hull. Computational capability must be figured into the decision to use a more complicated algorithm. In a preferred embodiment, the present invention utilizes the convex hull because it is simple and communicates well enough for the primary fielded application, but the present invention is not limited to the use of a convex hull algorithm.

Alternate polygon shape algorithms can provide added clarity if desired. The rightmost grid 805 of FIG. 8 shows an alternate algorithm that forms a group shape 806 that more intuitively conveys distribution information for assets in the group. This algorithm forms a group shape by using circle regions calculated around the center of mass for elements. The result is a shape that roughly outlines the main group of assets that are functionally contained in the group. The algorithm may not fully enclose all elements even though they are considered to be part of the group 807, but the overall shape is functionally meaningful because it conveys information about density of the grouping.

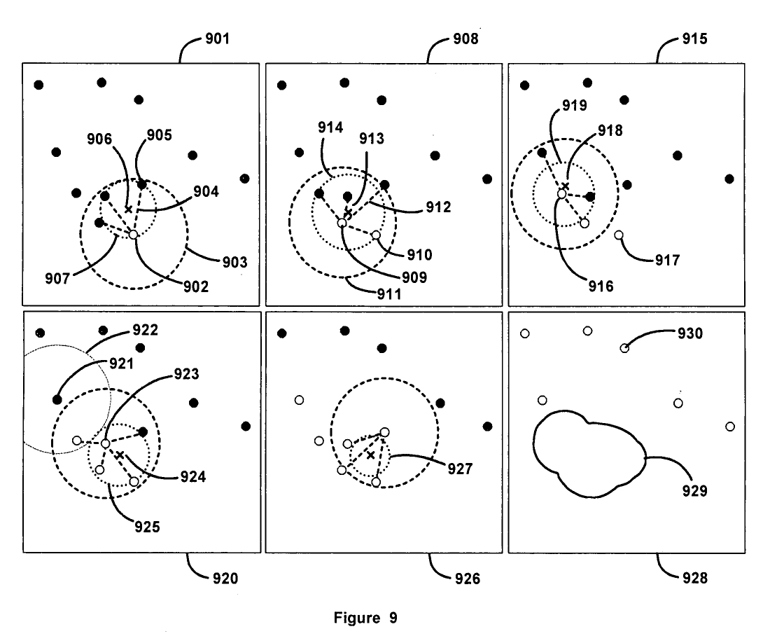

FIG. 9 depicts the algorithm used to create a more contoured shape indicative of the assets contained, as shown in grid 805 of FIG. 8 (although the precise shape shown in FIG. 9 is different). Six different panes are shown 901, 908, 915, 920, 926, 928 that depict the logical progression for the formation of the end shape 929. For any number of elements to be considered for grouping, the algorithm as depicted in FIG. 9 is applied.

Several algorithmic variables are used to form the shape. These variables, like the grid size and threshold discussed above, can be adapted to modify how the groups are formed and how the end shape profile appears when complete. The first variable is capture range. The capture range is depicted as element 903 with respect to asset 902. Other assets, such as 905 that are inside the capture range are considered for grouping with respect to element 902. The distance to each asset inside the capture range is calculated 904 and a center of mass is calculated 906 for all elements inside the capture range 903.

Distance measurement can be accurate or estimated using simple additions and subtractions and avoiding square root functions necessary to completely solve the Pythagorean range. The |L|+0.4|S| algorithm [see reference 5] can be used to closely approximate the coordinate range for two coordinate points x₁, y₁ to x₂, y₂.

The greater of the two difference values |(x₁−x₂)| or |(y₁−y₂)| is assigned to L, while the other value is assigned to S. The approximate range can be calculated with less than roughly five percent (5%) error as:

Range=The |L|+0.4|S|

The center of mass calculation for any N assets with a weighting index (mass) of each element m and total mass M in 2D space can be calculated as:

$$\begin{matrix}\begin{matrix}{x}_{cm} = \frac{{m}_{1} {x}_{1} + {m}_{2} {x}_{2} + … {m}_{N} {x}_{N}}{{m}_{1} + {m}_{2} + … {m}_{N}} = \frac{1}{M} {\sum }_{i = 1}^{N} {m}_{i} {x}_{i} \\ {y}_{cm} = \frac{{m}_{1} {y}_{1} + {m}_{2} {y}_{2} + … {m}_{N} {y}_{N}}{{m}_{1} + {m}_{2} + … {m}_{N}} = \frac{1}{M} {\sum }_{i = 1}^{N} {m}_{i} {y}_{i}\end{matrix}\end{matrix}$$

The center of mass is the location that best characterizes the center of the assets in the capture range. As explained below, the mass terms can be used to determine the center of mass location in a number of different ways. For example, the mass of the base asset for each calculation, such as 902 for pane 901, may be higher than the other assets considered in the capture range. Another approach is to inversely weight the mass as a function of the range from the base unit, giving more weight to closer assets and less weight to the distant assets in the capture range. Most simply, the mass of each unit may be uniform, making the calculation simpler still and requiring only one division by the total number of assets considered (M, assuming mass of each element is a uniform 1).

Once the center of mass is found 906, a shape circle 907 is calculated with the center of mass as the origin. The radius of the shape circle is a function of the mean range calculated. This mean range is the average of each of the ranges from the original point 902 to each asset to be considered in the capture range. The radius may be scaled from the average, in that a scalar value may be multiplied with the range to create the shape circle radius. This is one of the variables used to set the end shape of the polynomial.

Another alternative in the calculation of the radius of the shape circle may be to weight the radius by the number of assets considered, thus creating a larger shape that is proportional to the number of assets. This approach may also include the computation of mean range with the scalar as discussed, to produce shapes that reflect the number and distribution of assets contained.

The shape circle is retained (center and radius) as all points are considered similarly. Pane 908 shows the second point to be considered 909. Point 910 is shown as a white circle indicating it has already been processed. Again the capture range 911 is used to select all assets for consideration relative to point 909 with distances calculated 912. A center of mass is calculated 913 and a shape circle 914 calculated and plotted.

The process continues in pane 915 with point 916 considered, center of mass 918 calculated and shape circle 919 plotted. Note that point 917, as the original point considered, is outside the shape range of 916 so it is not considered in the calculation of center of mass 918.

The process continues recursively for all elements to be considered. Pane 920 shows the next point 923 considered with center of mass 924 and shape circle 925 plotted. It also shows asset 921 with a shape circle 922 capturing only one asset 926. Another variable of the algorithm is a threshold, used similarly to the threshold in the grid discussion previous, wherein the capture circle must capture a minimum number of assets exceeding the threshold before a center of mass and shape circle is calculated. For the purposes of this example, we shall assume the threshold is 2; thus, since only one asset is captured in 922, no shape circle for asset 921 is plotted.

The process is repeated in pane 926, plotting shape circle 927, and concluded in pane 928. where the shape circles are joined to create a composite polygon where they overlap. The assets that created shape circles are removed from the display as they are contained in the group represented by the composite shape. The assets that are too sparsely positioned to fail the capture test such as element 930 are left as individual assets to display.

Depending on how the user variables are set, the resulting shape may or may not totally enclose the assets grouped. The capture range and threshold, weighted mass and shape circle range greatly influence the resulting shape of the polygons. This algorithm has the advantage of not requiring gridding of the display with the potential separation of groups due to grid boundary bisection of assets. The groups are naturally formed by overlap of the shape circles.

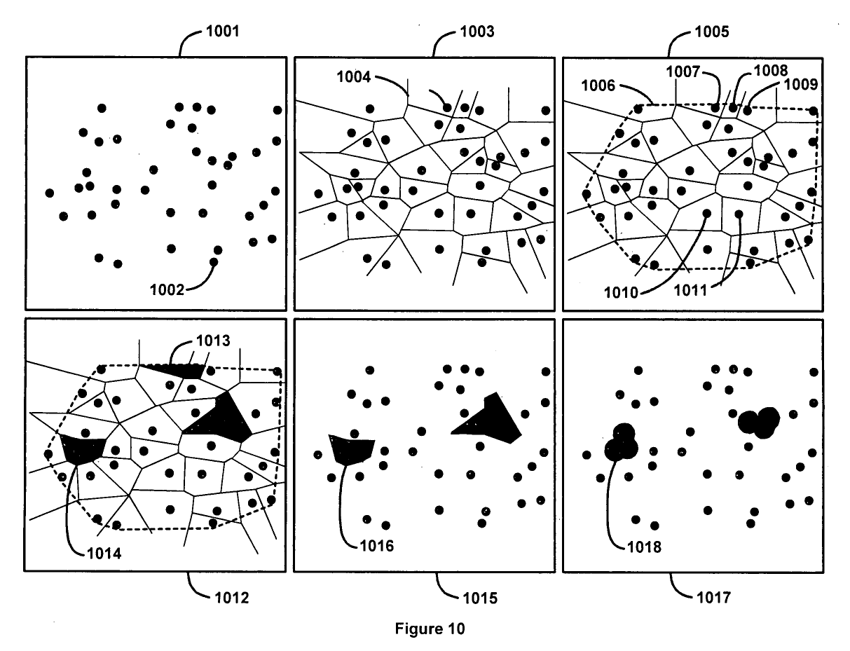

Another method for naturally forming groups without the need to grid the display is by forming a Voronoi diagram from the asset locations. A Voronoi diagram seeks to draw lines that define a region of influence around all given points based on the proximity of other points nearby [see references 4, 6, 7]. As such, the area for each Voronoi region is indicative of the density of points nearby. FIG. 10 depicts how the Voronoi algorithm could be used to make a determination as to which points are to be grouped. The figure shows six panes, 1001, 1003, 1005, 1010, 1012 and 1014 that describe how the algorithm may be used to select groups.

Pane 1001 shows a display with a distribution of assets such as 1002. Applying a Voronoi algorithm to the display results in the display shown in region 1003 with the line segments 1004 marking the region of influence for each point. Because the outside points are not influenced by adjacent points due to the artificial boundary of the display zoom scale, the regions for the outside points have some indeterminate weight. Applying a convex hull algorithm to all points 1006 creates an adaptation to the Voronoi set of lines, bounding the outside areas. This tends to create artificially smaller regions on the perimeter, which effect can be somewhat minimized by expanding the convex hull perimeter by a scaled offset toward the display boundaries. This scaled offset can be a selectable feature. As shown in 1006, the offset is zero. Pane 1005 shows the combination of the convex hull and the Voronoi algorithms, creating finite regions of influence for each asset point.

The area of each region is a function of the density of points nearby, thus regions around assets 1007 and 1008 are small in comparison to less densely positioned assets such as 1010 and 1011. An area threshold can be used to select which regions are small enough to consider for grouping. This area threshold can be variable, user selectable or fixed as the application requires. Pane 1012 shows the selection of asset regions that are below an arbitrary area threshold.

The region 1013 is the consolidation of two asset regions. The region 1014 is the consolidation of three asset regions. Applying a second minimum count threshold may further deselect some group region determinations. While the regions surrounding 1007 and 1008 are small enough to consider for grouping, a minimum count threshold of 3 as an example would deselect the grouping of 1007 and 1008 as a new group. The region 1014 however contains three asset regions and thus satisfies the minimum count threshold to be considered as a group.

Pane 1015 shows the surviving groups to be formed from this algorithm. It may be acceptable to simply leave the consolidated Voronoi regions as the group definition as shown in 1016. This shape may not satisfy the user interface requirements, however. In that event, the points selected can be simply radial shaded as shown in pane 1017, or more suitably combined using the converse hull or center of mass methods as discussed previously.

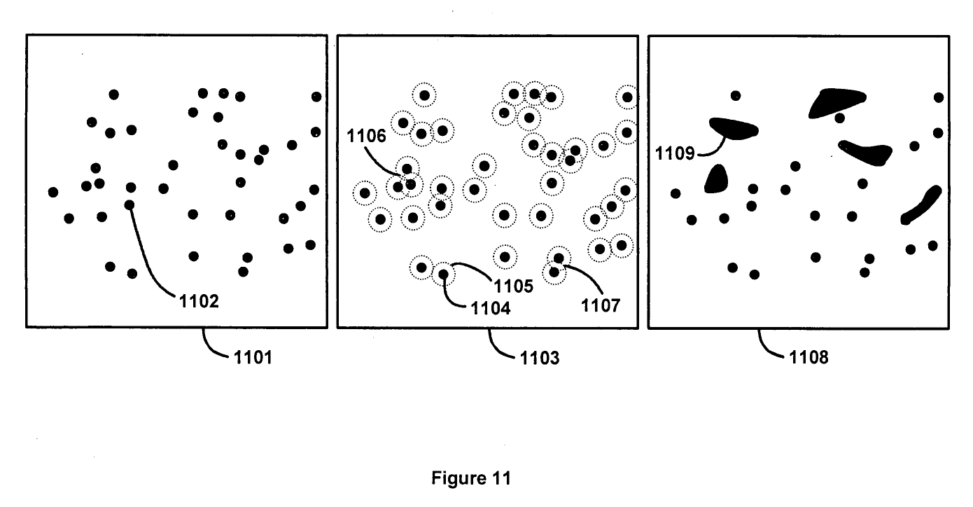

Another method for forming groups without gridding the display is to simply apply a radial intercept algorithm as depicted in FIG. 11. Pane 1101 shows a distribution of assets such as 1102 to be considered for grouping. Applying a radial region to each asset as shown in pane 1103 creates some regions of overlap 1106 and 1107 which create candidate assets for grouping. The radius of the radial region is variable, user selectable or fixed. A minimum count threshold may also be applied as before, limiting the minimum number of assets to be grouped. The example shown in FIG. 11 assumes this minimum count threshold to be 3, thus the regions overlapping in 1106 would create a group while the regions overlapping in 1107 would not. The result is shown in pane 1108, with grouped assets 1109 containing 3 or more assets. The shape of the grouped region can be any of the above mentioned algorithms or similar method for representing the shared assets.

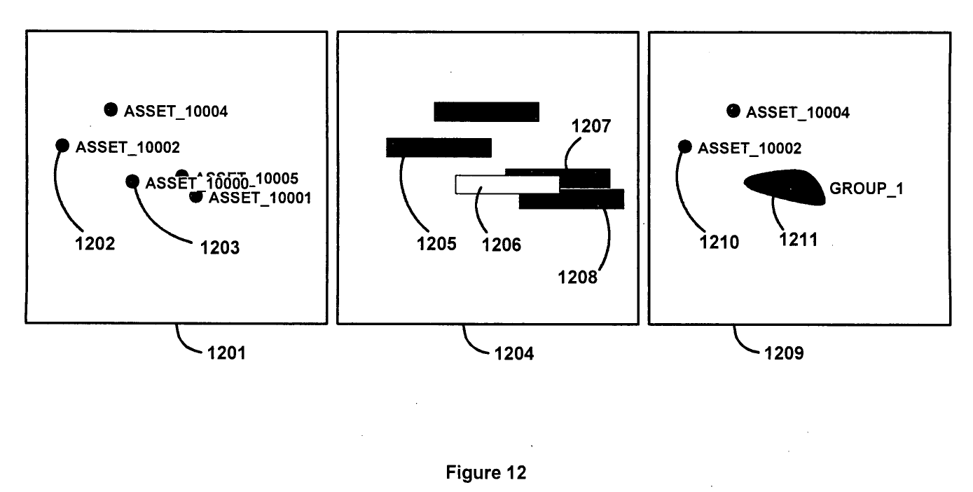

In still another method for determining which assets are to be grouped, consideration of the ancillary displayed data could be used to accomplish the mission of un-cluttering the display for the end user. Since the asset location can be represented in a small number of physical pixels on a display, the predominant number of pixels of use may be a data component displayed next to the asset icon. This is typically the case for asset displays where a user may wish an identification field or time or status component reported next to the icon representing location. As such, the text or graphic ancillary component also uses screen resolution and when overlapped becomes unreadable and distracting. This method is illustrated in FIG. 12.

FIG. 12 shows a method for using the data field region overlap as a decision mechanism for determining which assets are to be grouped. Pane 1201 shows 5 assets on a display, each with an identification data element adjacent to the icon location. Asset 1202 is readable, but asset 1203 is obscured by the text of the adjacent assets.

Pane 1204 shows the analysis of evaluating the regions that contain the data displayed. Each text field is allocated a region 1205, and an overlap determination is made resulting in detection of region 1206 overlapping regions 1207 and 1208. The overlapped text regions nominate the three assets to be grouped. Pane 1209 shows the resulting display where asset 1210 is left unchanged since the text region 1205 was not overlapping any other text regions. The three assets with overlapping regions are grouped 1211 with the assets shaped using one of the algorithms discussed previously. As with other methods, a threshold may be applied as a deciding factor for readability of overlapped text.

Much detail has been provided regarding the creation and display shape of groups of assets. The algorithms used to create these shapes are drawn from prior art, and there exist many other algorithms that may be suitable. The algorithm used in the present invention, however, must be tailored to the application with the objective of communicating something about the assets contained in an intuitive manner while simultaneously minimizing the amount of data that must be relayed to the display terminal for any given zoom level.

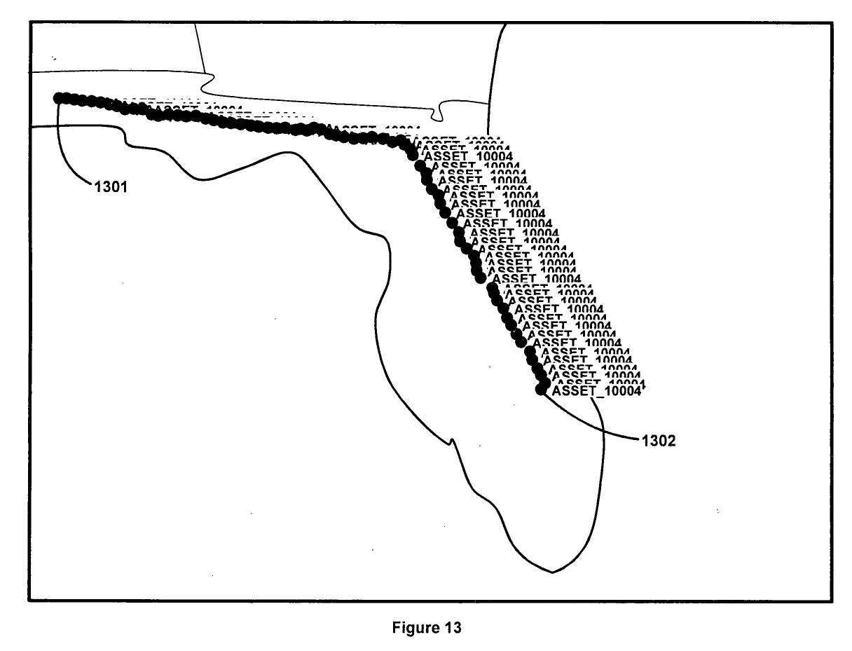

The preceding discussion focused on ways to reduce the amount of information displayed at any one time to both add clarity of information and reduce the amount of data to transfer to any remote display terminal. A similar problem exists when any given asset relays information at a rapid rate, or a lot of information for any given asset is to be displayed concurrently. Modern day asset tagging devices can communicate over terrestrial cellular networks frequently, even every few seconds, providing detailed series of location points often referred to as breadcrumbs. An asset tagged with a device that provides location updates even every few minutes create a large amount of data to display if all the reports were concurrently shown. Such a breadcrumb trail for even one asset might appear to a user as shown in FIG. 13. A single asset 1301 reporting frequently while driving through Florida would result in a smear of icons, many overlapping from the beginning of the observation interval, which may be represented by 1301, to the terminus, which may be represented as 1302. The points in between are essentially overlapped into a solid line, obscuring map detail and often other assets performing similar functions. Imagine this same display with 1000 assets, all reporting at similar rates. The problem is worsened if the asset also carries an identification or time tag of data as shown. While the display of FIG. 13 conveys the track of the asset, it becomes unmanageable when combined with other tracks or data elements.

Furthermore, each point to be plotted invariably results in a point of data transferred from the core database to the display terminal, which increases the costs of wireless transmission. This large amount of data is often no more useful to the end user than a few points along the path.

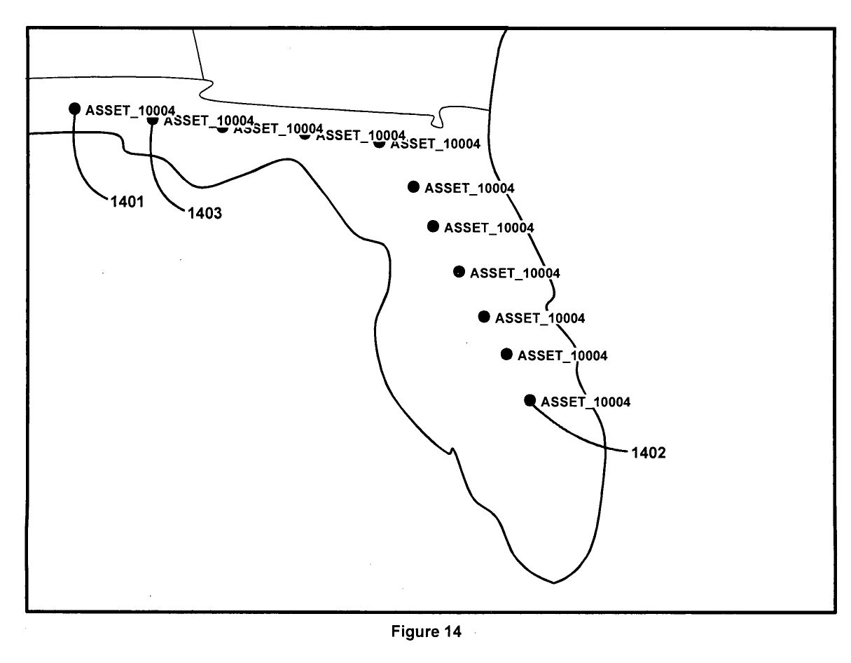

The present invention utilizes decimation techniques to provide added clarity and reduced data transfer for any given asset. FIG. 14 depicts the same data set with a decimation factor of 6 applied. Points 1401 and 1402 pair to points 1301 and 1302; however, the points in between represent ⅙^{th} of the overall data points, which not only enables easier reading for the asset data tag but also reduces the number of points to transfer data by the same ratio. The decimation factor can be automatic or set by the user as needed. Additionally, scaling the display through zoom will fill in the decimated points so that no detail is lost. Instead, the detail is scaled to provide the clarity desired while preserving information desired and reducing transmission data.

The decimation may be a set ratio, or alternatively the decimation may be provided as a function of distance. Assets that move slowly for a period of travel and rapidly for others need not use a uniform decimation ratio; instead, the decimation may select points along a route that roughly establish a target distance between points.

The decimation ratio may also be automatically selected by a minimum asset gap distance for any selected display resolution. In this manner, no two points will be plotted any closer than the specified display distance, thereby providing ample room for any displayed data component.

If the asset data contains time, it is also sometimes valuable to perform decimation to present points that are roughly temporally spaced. Any data attribute may be used to select the points to be displayed. For example, if the data contained engine run temperature or speed, the user may only be interested in seeing assets that are operating above a specified speed or above an acceptable operating temperature, further reducing the data to that of interest while reducing transmission requirements.

The user may also set the decimation function as any combination of data. For example, the user may only wish to see data no more often than every 15 minutes and only for assets operating above a given speed.

Grouping assets for display creates such a reduction in data transfer that it enables true thin-client software applications even while managing very large numbers of assets. Thin-client means that the remote computer program need merely be an internet browser with minimal software graphic applications as opposed to thick-client applications that require a full user software program be installed in every endpoint computer, often at significant software cost per installation.

The grouping function allows for almost uniform data transfer for any view scale, enabling thin-client use that in turn allows for thousands of users accessing database information on tens of thousands of assets without the need to install costly software at each monitoring computer. The logistical problem of keeping software current on thousands of thick-client users is thus removed, as all users are automatically using latest version software readily accessible over brief downloads over the internet.

Many modifications and other embodiments of the invention will come to the mind of one skilled in the art having the benefit of the teachings presented in the foregoing descriptions and the associated drawings. Accordingly, it is understood that the invention is not to be limited to the embodiments disclosed, and that other modifications and embodiments are intended to be included within the spirit and scope of the appended claims.

### REFERENCES

1. Graham, Ronald, “An Efficient Algorithm for Determining the Convex Hull of a Finite Point Set,” Info. Proc. Letters 1, 132-133 (1972).

2. Preparata, Franco, and Hong, S. J., “Convex Hulls of Finite Sets of Points in Two and Three Dimensions,” Comm. ACM 20, 87-93 (1977).

3. Skiena, S. S., “Convex Hull,” The Algorithm Design Manual (New York: Springer-Verlag, 1997).

4. O'Rourke, Joseph, Computational Geometry in C (New York: Cambridge University Press, 1994).

5. Frerking, Marvin E., Digital Signal Processing in Communication Systems (New York: Van Nostrand Reinhold, 1994).

6. de Berg, M., et al., “Convex Hulls: Mixing Things,” Computational Geometry: Algorithms and Applications, 2nd rev. ed. (Berlin: Springer-Verlag, 2000).

7. Skiena, Stephen S., “The Stony Brook Algorithm Repository,” Department of Computer Science State University of New York Home Page (7 Mar. 2001 <http://www.cs.sunysb.edu/˜algorith/files/voronoi-diagrams.shtml>).

We claim:

1. A system for graphically displaying information concerning geographically dispersed assets, comprising:
(a) a computer program that associates map and/or geographical data with a physical asset;
(b) an icon or other graphical representation of each dispersed asset; and
(c) an automatic grouping function,
wherein the automatic grouping function combines at least two of the assets into a single icon or other graphical representation of the multiplicity of assets, and
wherein the automatic grouping function generates a shape that represents the grouped assets.

2. The system of claim 1, wherein the automatic grouping of dispersed assets proportionally reduces data transmitted to a remote display terminal.

3. The system of claim 1, further comprising a display, wherein the automatic grouping function partitions the display into regions, sums the number of assets in each region, compares each sum of assets to a threshold, and groups assets in a region that exceeds a given threshold.

4. The system of claim 3, wherein each display region comprises one or more boundaries, and
wherein the automatic grouping function determines whether any of the asset groups share a point or points on a region boundary, and if so, whether any adjacent groups share the same point or point on the same region boundary, and if so, combines the groups into a single group.

5. The system of claim 1, wherein the automatic grouping function calculates candidate nearest neighbor assets within a limit distance for each asset, calculates a center of mass for the candidate nearest neighbor assets, calculates a radial shape range using the calculated center of mass as origin, and concatenates radial shape ranges that overlap to create groups of assets inside the limit distance that was used to perform the nearest neighbor calculation.

6. The system of claim 1, wherein the automatic grouping function calculates a radial region around each asset and concatenates overlapping radial regions to define assets to be grouped.

7. The system of claim 1, wherein the shape representing the grouped assets is generated using concatenated areas of calculated Voronoi regions.

8. The system of claim 1, wherein the automatic grouping function calculates a Voronoi region set for each asset, calculates the area of each Voronoi region, compares each region to a threshold, and concatenates adjacent regions that are below the threshold to define the assets to be grouped.

9. The system of claim 1, wherein the automatic grouping function calculates a data region for each asset, determines whether any of the data regions overlap, and groups assets that have overlapping data regions, and
wherein the data region comprises data to be displayed adjacent to the icon or other graphical representation of the asset.

10. The system of claim 1, wherein the shape representing the grouped assets is generated using a convex hull algorithm.

11. The system of claim 1, wherein the shape representing the grouped assets is generated using an arithmetic weighted center of mass algorithm.

12. The system of claim 1, whereby the shape representing the grouped assets is generated using concatenated radial circle areas around nominated assets.

13. The system of claim 1, wherein the map and/or geographical data associated with an asset is displayed on a remote display terminal,
wherein the data for any given asset is associated with a number of data points,
wherein a first data point for a given asset is plotted, and successive data points for the same asset are skipped using a decimation algorithm until all of the data points for a given asset have been exhausted.

14. The system of claim 13, wherein the decimation algorithm comprises skipping plotting successive data points of the same asset until a successive data point is at least a minimum distance from the previous data point.

15. The system of claim 13, wherein the decimation algorithm comprises skipping plotting successive data points of the same asset using a set decimation ratio.

16. The system of claim 13, wherein the decimation algorithm comprises skipping plotting successive data points of the same asset according to a minimum time difference using time data associated with each data point.

17. The system of claim 13, wherein the decimation algorithm comprises skipping plotting successive data points of the same asset until a data component associated with each data point is in the range of a prescribed threshold.

18. The system of claim 1, wherein the computer program operates as a thin client application,
wherein the computer program receives the map and/or geographic data wirelessly, and
wherein the data is automatically grouped proportionally to the display resolution prior to wireless communication.

19. A method for graphically displaying information concerning geographically dispersed assets, comprising:
(a) using a computer program to associate map and/or geographical data with a physical asset;
(b) representing each dispersed asset with an icon or other graphical representation on a display; and
(c) using an automatic grouping function to combine at least two of the assets into a single icon or other graphical representation of the multiplicity of assets and generate a shape that represents the grouped assets.

20. The method of claim 19, wherein the automatic grouping of dispersed assets proportionally reduces data transmitted to a remote display terminal.

21. The method of claim 19, further comprising using the automatic grouping function to partition the display into regions, sum the number of assets in each region, compare each sum of assets to a threshold, and group assets in a region that exceeds a given threshold.

22. The method of claim 21, wherein each display region comprises one or more boundaries, further comprising using the automatic grouping function to determine whether any of the asset groups share a point or points on a region boundary, and if so, whether any adjacent groups share the same point or points on the same region boundary, and if so, combine the groups into a single group.

23. The method of claim 19, further comprising using the automatic grouping function to calculate candidate nearest neighbor assets within a limit distance for each asset, calculate a center of mass for the candidate nearest neighbor assets, calculate a radial shape range using the calculated center of mass as origin, and concatenate radial shape ranges that overlap to create groups of assets inside the limit distance that was used to perform the nearest neighbor calculation.

24. The method of claim 19, further comprising using the automatic grouping function to calculate a radial region around each asset and concatenate overlapping radial regions to define assets to be grouped.

25. The method of claim 19, further comprising using concatenated areas of calculated Voronoi regions to generate the shape representing the grouped assets.

26. The method of claim 19, further comprising using the automatic grouping function to calculate a Voronoi region set for each asset, calculate the area of each Voronoi region, compare each region to a threshold, and concatenate adjacent regions that are below the threshold to define the assets to be grouped.

27. The method of claim 19, further comprising using the automatic grouping function to calculate a data region for each asset, determine whether any of the data regions overlap, and group asset that have overlapping data regions,
wherein the data region comprises data to be displayed adjacent to the icon or other graphical representation of the asset.

28. The method of claim 19, further comprising using a convex hull algorithm to generate the shape representing the grouped assets.

29. The method of claim 19, further comprising using an arithmetic weighted center of mass algorithm to generate the shape representing the grouped assets.

30. The method of claim 19, further comprising using concatenated radial circle areas around nominated assets to generate the shape representing the grouped assets.

31. The method of claim 19, further comprising displaying the map and/or geographical data associated with an asset on a remote display terminal,
wherein the data for any given asset is associated with a number of data points,
further comprising plotting a first data point for a given asset and skipping successive data points for the same asset using a decimation algorithm until all of the data points for a given asset have been exhausted.

32. The method of claim 31, wherein the decimation algorithm comprises skipping plotting successive data points of the same asset until a successive data point is at least a minimum distance from the previous data point.

33. The method of claim 31, wherein the decimation algorithm comprises skipping plotting successive data points of the same asset using a set decimation ratio.

34. The method of claim 31, wherein the decimation algorithm comprises skipping plotting successive data points of the same asset according to a minimum time difference using time data associated with each data point.

35. The method of claim 31, wherein the decimation algorithm comprises skipping plotting successive data points of the same asset until a data component associated with each data point is in the range of a prescribed threshold.

36. The method of claim 1, wherein the computer program operates as a thin client application,
wherein the computer program receives the map and/or geographic data wirelessly,
further comprising automatically grouping the data proportionally to the display resolution prior to wireless communication.
